(19) United States
(12) Patent Application Publication
(10) Pub. No.: US 2026/0320798 A1
(43) Pub. Date: Oct. 15, 2026

(54) METHODS AND APPARATUS FOR SIGNAL CORRECTION FOR DYNAMIC CONFOCAL MICROSCOPY

(71) Applicant: The General Hospital Corporation, Boston, MA (US)

(72) Inventors: Guillermo Tearney, Boston, MA (US); Jintaek Im, Boston, MA (US); Junyoung Kim, Boston, MA (US); David Odeke Otuya, Boston, MA (US)

(21) Appl. No.: 19/482,218

(22) PCT Filed: May 16, 2024
(86) PCT No.: PCT/US2024/029663

§ 371 Date: Nov. 6, 2025

Related U.S. Application Data
(60) Provisional application No. 63/502,627, filed on May 16, 2023.

(51) Int. Cl. G06T 7/00; G02B 21/00; G06T 5/70

(52) U.S. Cl. CPC G06T 7/0014; G02B 21/0032; G02B 21/0048; G02B 21/0072; G06T 5/70; G06T 2207/10056

(57) ABSTRACT

A method of signal correction for dynamic confocal microscopy, including: directing a first portion of an output of a light source to a sample; collecting, using a first detector, first light returned from the sample to generate a sample image; directing a second portion of the output of the light source to a fiber Bragg grating; collecting, using a second detector, second light returned from the fiber Bragg grating to generate a reference image, the reference image including a plurality of rows; analyzing the reference image to identify an amount of delay in each row of the plurality of rows of the reference image; and producing a corrected sample image by adjusting each row of the plurality of rows of the sample image based on identifying the amount of delay in each row of the plurality of rows of the reference image.

### CROSS-REFERENCE TO RELATED APPLICATIONS

The present application is based on and claims priority from U.S. patent application Ser. No. 63/502,627, filed on May 16, 2023. The entire disclosure of which is incorporated herein by reference.

### STATEMENT REGARDING FEDERALLY SPONSORED RESEARCH

N/A.

### BACKGROUND

Spectrally encoded confocal microscopy (SECM) is a high-speed form of reflectance confocal microscopy (RCM). As opposed to scanning a single focused optical beam in RCM, SECM spreads out light using a diffraction grating and focuses this diffracted light onto a sample, thereby encoding each lateral coordinate by a particular wavelength of light. Dynamic image analysis is a process where pixelwise periodograms are generated by taking subsequently captured images and analyzing the frequency distribution of each pixel or region of interest (ROI). Since motion and reconfiguration of organelles, cytoskeleton, and molecules within cells is ATP dependent, these frequency components can then be related to subcellular metabolic activity. While this method of dynamic image analysis has been applied to optical coherence tomography (OCT), it has not yet been extended to dynamic confocal microscopy procedures such as RCM or SECM.

### SUMMARY OF THE INVENTION

Accordingly, new systems, methods, and apparatus for signal correction for dynamic confocal microscopy are desirable.

The method of dynamic image analysis has high compatibility with RCM and SECM imaging to achieve more pathological and morphological information on the biological sample. To enable dynamic RCM and SECM, procedures disclosed herein first provide ways to stabilize collected image data. This stabilization can then be combined with other image correction procedures, including artifact removal routines to obtain improved dynamic SECM images.

In one embodiment, a method of signal correction for dynamic confocal microscopy, including: directing a first portion of an output of a light source to a sample; collecting, using a first detector, first light returned from the sample to generate a sample image; directing a second portion of the output of the light source to a fiber Bragg grating; collecting, using a second detector, second light returned from the fiber Bragg grating to generate a reference image, the reference image including a plurality of rows; analyzing the reference image to identify an amount of delay in each row of the plurality of rows of the reference image; and producing a corrected sample image by adjusting each row of the plurality of rows of the sample image based on identifying the amount of delay in each row of the plurality of rows of the reference image.

In some embodiments of the method, the light source may include a swept-source laser. In some embodiments of the method, directing the first portion of the output of the light source to the sample includes directing a first portion of the output of the swept-source laser to the sample, and directing the second portion of the output of the light source to the fiber Bragg grating. In some embodiments of the method, directing second portion of the output of the swept-source laser to the fiber Bragg grating.

Some embodiments of the method may also include analyzing the reference image to identify an amount of a delay in each row in the plurality of rows may include performing a cross-correlation between a reference row and each of a plurality of rows of the reference image. In some embodiments of the method, analyzing the reference image may further include identifying an amount of shift between the reference row and each of the plurality of rows of the reference image. In some embodiments of the method, analyzing the reference image may still further include identifying the amount of delay in each row of the reference image based on identifying the amount of shift.

In some embodiments of the method, the method may also include obtaining a plurality of sample images which correspond to a different time point. Each sample image of the plurality of sample images may include a plurality of pixels which each represent an intensity value. In some embodiments of the method, the method may further include producing a plurality of time courses of intensity values for each of the plurality of pixels in the plurality of sample images. In some embodiments of the method, producing the corrected sample imaging may include reducing a stripe artifact in each of the plurality of time courses of intensity values using frequency domain processing.

In some embodiments of the method, the method may include an additional step of removing a DC component from the time course of intensity values before reducing the stripe artifact.

In various embodiments of the method, the method may include generating a plurality of periodograms corresponding to each of the plurality of time courses of intensity values, and dividing each of the plurality of periodograms into a plurality of frequency bands. The method may include generating the plurality of periodograms using Welch's method. In some embodiments of the method, dividing each of the plurality of periodograms into a plurality of frequency bands further includes adjusting an appearance of the corrected sample image based on dividing each of the plurality of periodograms into the plurality of frequency bands. In still more embodiments of the method, adjusting the appearance of the corrected sample image bands may include adjusting at least one of a color or a brightness of each of the plurality of pixels based on the periodogram of the respective pixel.

In certain embodiments of the method, at least one of the color or brightness of each of the plurality of pixels of the corrected sample image represents an activity level of the sample in a region corresponding to the pixel.

Some embodiments of the method may further include directing a first portion of an output of a swept-source laser to a sample further includes directing the first portion of the output of the swept-source laser to the sample using a diffraction grating coupled to a galvanometer scanner. In some embodiments of the method, the diffraction grating includes a reflection grating. In some embodiments of the method, the diffraction grating includes a diffracting grating. In any embodiment of the method which include a diffraction grating coupled to a galvanometer scanner, the diffraction grating is coupled to the galvanometer scanner in a parallel configuration or a perpendicular configuration.

In various embodiments of the method, the method may include correcting the sample image for a fan-shaped distortion pattern caused by scanning the sample with the diffraction grating coupled to the galvanometer scanner. In some embodiments of the method, correcting the sample image for a fan-shaped distortion pattern may include: extracting a plurality of reference coordinates from the sample image; determining a plurality of target coordinates in a corrected sample image corresponding to the respective plurality of reference coordinates; generating a transformation matrix to transform the plurality of reference coordinates to the plurality of target coordinates, and generating the corrected sample image based on applying the transformation matrix to the sample image. In some embodiments, correcting the sample for a fan-shaped distortion pattern may also include identifying at least one of a wavelength range of the swept-source laser or an angle of the galvanometer scanner based on correcting the sample image for the fan-shaped distortion pattern.

In particular embodiments of the method, the dynamic confocal microscopy include at least one of spectrally-encoded confocal microscopy (SECM) or reflectance confocal microscopy (RCM).

In various embodiments of the method, directing a first portion of the output of the light source to a sample also includes scanning the light source across the sample using a scanning mechanism including at least one of galvo scanning, piezo scanning, Risley prism scanning, or Nipkow spinning scanning.

In some embodiments of the method, collecting the first light returned from the sample and collecting the second light returned from the fiber Bragg grating includes stabilizing the collected first light and second light to at least one of reduce, prevent, or correct for motion of at least one of the sample or a data collection system. In some embodiments of the method, the data collection system includes at least one of the first detector or the second detector. In some embodiments of the method, stabilizing the collected first light and second light includes applying unwarping stabilization processing to the collected first light and second light.

In various embodiments of the method, directing the first portion of the output of the light source to the sample and directing the second portion of the output of the light source to the fiber Bragg grating includes coupling a scanning device including the light source to the sample. Coupling the scanning device to the sample may include coupling the scanning device to the sample using a flexible joint or a stabilizer. In particular embodiments of the method, the scanning device also includes a position sensor. In some embodiments of the method, the first portion of the output of the light source to the sample and directing the second portion of the output of the light source to the fiber Bragg grating may include obtaining position information for the scanning device using the position sensor and correcting a position of the scanning device based on the position information.

In some embodiments of the method, collecting the first light returned from the sample and collecting the second light returned from the fiber Bragg grating may include stabilizing a focus along a depth axis of the sample. Stabilizing the focus along the depth axis of the sample may include at least one of: moving an objective lens coupled to the light source and the first detector; providing a variable focal length objective lens coupled to the light source and the first detector; or obtaining volumetric data from the sample and subsampling the volumetric data to obtain the sample image.

In another embodiment, an apparatus for signal correction for dynamic confocal microscopy, including: a light source configured to be optically coupled to a sample; a fiber Bragg grating optically coupled to the light source; a first detector and a second detector; and a controller in communication with the light source and the first detector and the second detector, the controller being configured to: direct a first portion of an output of the light source to the sample, collect, using the first detector, first light returned from the sample to generate a sample image, direct a second portion of the output of the swept-source laser to the fiber Bragg grating, collect, using the second detector, second light returned from the fiber Bragg grating to generate a reference image, the reference image including a plurality of rows, analyze the reference image to identify an amount of delay in each row of the plurality of rows of the reference image, and produce a corrected sample image by adjusting each row of the plurality of rows of the sample image based on identifying the amount of delay in each row of the plurality of rows of the reference image.

In various embodiments of the apparatus, the light source includes a swept-source laser. In some embodiments of the apparatus, the controller, directing the first portion of the output of the light source to the sample is configured to direct the first portion of the output of the swept-source laser to the sample. In some embodiments of the apparatus, the controller, when directing the second portion of the output of the light source to the fiber Bragg grating is further configured to direct the second portion of the output of the swept-source laser to the fiber Bragg grating.

In certain embodiments of the apparatus, the controller, when analyzing the reference image to identify an amount of delay in each row of the plurality of rows of the reference image, is further configured to perform a cross-correlation between a reference row and each of a plurality of rows of the reference image. The controller may be further configured to identify an amount of shift between the reference row and each of the plurality of rows of the reference image. In some embodiments of the apparatus, the controller may be configured to identify the amount of delay in each row of the reference image based on identifying the amount of shift.

Some embodiments of the apparatus may further include that the controller is configured to obtain a plurality of sample images, each of which corresponds to a different time point. In some embodiments of the apparatus, each sample image of the plurality of sample images includes a plurality of pixels each representing an intensity value. In some embodiments, the controller is further configured to produce a plurality of time courses of intensity values for each of the plurality of pixels of the plurality of sample images. The controller may, when producing the corrected sample image, be configured to produce the corrected sample image by reducing a stripe artifact in each of the plurality of time courses of intensity values using frequency domain processing.

In particular embodiments of the apparatus, the controller may be configured to remove a DC component from the time course of intensity values before reducing the stripe artifact.

In certain embodiments of the apparatus, the controller may be further configured to generate a plurality of periodograms corresponding to each of the plurality of time courses of intensity values and divide each of the plurality of periodograms into a plurality of frequency bands. The controller, when generating a plurality of periodograms corresponding to each of the plurality of time courses of intensity values, may be further configured to generate the plurality of periodograms using Welch's method. In some embodiments of the apparatus, the controller, when dividing each of the plurality of periodograms into a plurality of frequency bands, may be further configured to adjust an appearance of the corrected sample image based on dividing each of the plurality of periodograms into the plurality of frequency bands. In particular embodiments of the apparatus, at least one of a color or a brightness of each of the plurality of pixels is adjusted based on the periodogram of the respective pixel. In some embodiments of the apparatus, at least one of the color or brightness of each of the plurality of pixels of the corrected sample image represents an activity level of the sample in a region corresponding to the pixel.

In various embodiments of the apparatus, the apparatus may further include a galvanometer scanner in communication with the controller. In some embodiments of the apparatus, the galvanometer scanner is coupled to a diffraction grating, and the controller, when directing a first portion of an output of a swept-source laser to a sample, is further configured to direct the first portion of the output of the swept-source laser to the sample using the diffraction grating coupled to the galvanometer scanner. In some embodiments of the apparatus, the diffraction grating includes a reflection grating. In some embodiments of the apparatus, the diffraction grating includes a transmission grating. In any embodiment of the apparatus which includes diffraction grating, the diffraction grating may be coupled to the galvanometer scanner in a parallel configuration or a perpendicular configuration.

In some embodiments of the apparatus, the controller is further configured to correct the sample image for a fan-shaped distortion pattern caused by scanning the sample with the diffraction grating coupled to the galvanometer scanner. In some embodiments of the apparatus, the controller, when correcting the sample for a fan-shaped distortion pattern, is further configured to: extract a plurality of reference coordinates from the sample image; determine a plurality of target coordinates in a corrected sample image corresponding to the respective plurality of reference coordinates; generate a transformation matrix to transform the plurality of reference coordinates to the plurality of target coordinates; and generate the corrected sample image based on applying the transformation matrix to the sample image. In some embodiments of the apparatus, the controller may be further configured to identify at least one of a wavelength range of the swept-source laser or an angle of the galvanometer scanner based on correcting the sample image for the fan-shaped distortion pattern.

In particular embodiments of the apparatus, the dynamic confocal microscopy may include at least one of spectrally-encoded confocal microscopy (SECM) or reflectance confocal microscopy (RCM).

Some embodiments of the apparatus may also include a scanning mechanism including at least one of galvo scanning, piezo scanning, Risley prism scanning, or Nipkow spinning scanning. In some embodiments of the apparatus, the controller, when directing the first portion of the output of the light source to a sample, may also be configured to scan the light source across the sample using scanning mechanism.

In various embodiments of the apparatus, the apparatus may also include a data collection system including at least one of the first detector or the second detector. In some embodiments of the apparatus, the controller, when collecting the first light returned from the sample and collecting the second light returned from the fiber Bragg grating, may be further configured to stabilize the collected first light and second light to at least one of reduce, prevent, or correct for motion of at least one of the sample or the data collection system.

In some embodiments of the apparatus, the controller, when stabilizing the collected first and second light, may be further configured to apply unwarping stabilization processing to the collected first light and second light.

In various embodiments of the apparatus, the apparatus may further include a scanning device including the light source to the sample. The controller, when directing the first portion of the output of the light source to the sample and directing the second portion of the output of the light source to the fiber Bragg grating, may be further configured to couple the scanning device to the sample. In some embodiments of the apparatus, the scanning device may be coupled to the sample using a flexible joint or a stabilizer. In particular embodiments of the apparatus, the scanning device may further include a position sensor, and the controller, when directing the first portion of the output of the light source to the sample and directing the second portion of the output of the light source to the fiber Bragg grating, may be further configured to obtain position information for the scanning device using the position sensor, and correct a position of the scanning device based on the position information. In some embodiments of the apparatus, the galvanometer scanner and the diffraction grating are disposed within the scanning device, and the scanning device includes a hand-held housing.

In various embodiments of the apparatus, the controller, when collecting the first light returned from the sample and collecting the second light returned from the fiber Bragg grating, is further configured to stabilize a focus along a depth axis of the sample.

Some embodiments of the apparatus may also include at least one of an objective lens or a variable focal length objective lens. In some embodiments of the apparatus, the controller, when stabilizing the focus along the depth axis of the sample, is further configured to at least one of: move an objective lens coupled to the light source and the first detector, provide a variable focal length objective lens coupled to the light source and the first detector, or obtain volumetric data from the sample and subsampling the volumetric data to obtain the sample image.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of an imaging system for dynamic confocal microscopy including RCM and dynamic SECM in accordance with some embodiments of the disclosed subject matter.

FIG. 2 shows an example of an arrangement of components that can be used to implement a system for dynamic RCM and dynamic SECM in accordance with some embodiments of the disclosed subject matter, including a light source, a data acquisition device, a stabilization device, and/or a scanning device.

FIGS. 3A-3B. Panel (a) shows 1951 USAF resolution target image that is scanned by a galvo scanner with data collected by an avalanche photodiode (APD) that is part of a data acquisition device. Panel (b) shows the time-stacked fiber Bragg grating (FBG) image that is collected using another APD that is part of a stabilization device.

FIGS. 4A-4D depict an algorithm for image jitter removal; panel (a) shows time-stacked FBG images. Panel (b) shows vertically stacked FBG signals. Panel (c) shows FBG signals aligned using the disclosed algorithm. Panel (d) shows a corrected FBG image.

FIGS. 5A-5B panel (a) shows a raw SECM image of a 1951 USAF resolution target with horizontal artifacts, and panel (b) shows artifact corrected SECM image of a 1952 USAF resolution target using the proposed algorithm; the lower left of each panel provides an inset including an enlarged portion of the image to show image detail.

FIG. 6 shows an example of hardware that can be used to implement a computing device and server in accordance with some embodiments of the disclosed subject matter.

FIG. 7 shows an example of a process for capturing and creating image data and functional dynamic data from biological sample in accordance with some embodiments of the disclosed subject matter.

FIGS. 8A-8C show exemplary diagrams of steps of a post-processing procedure for performing dynamic RCM and dynamic SECM (top row) along with sample images corresponding to each step (bottom row); panel (a) shows a raw image of a sample and FBG images with horizontal artifacts; panel (b) shows a corrected image of the sample and FBG images; and panel (c) shows removal of a stripe from the sample image.

FIGS. 9A-9D show an example of an algorithm for dynamic RCM and dynamic SECM: panel (a) shows a time-dependent stack of post-processed images of an ex-vivo swine colon. Three distinctive points or regions within the image are indicated as (a1) Epithelial cell, (a2) Stroma, (a3) Crypt lumen. Panel (b) shows pixelwise intensity graphs over time. Panel (c) shows a graph of DC removed intensity versus time. Panel (d) shows pixelwise periodogram graphs.

FIGS. 10A-10E show images of swine colon tissue. Panel (a) shows an 831-frame averaged SECM image of the colon tissue. Panel (b) shows the corresponding color-coded dynamic SECM image. Panel (c) shows a red-coded image channel at lower frequency range of 0.0-0.3 Hz. Panel (d) shows a blue color-coded image at mid-frequency range of 0.7-3.3 Hz. Panel (e) shows a green color-coded image channel at high-frequency range of 4.4-32.5 Hz.

FIG. 11 shows an example of a diffraction grating-attached galvo scanning arrangement, showing different configurations for attaching the grating depending on the diffraction grating type. Panel (a) is an example where the transmission grating is attached parallel to the rotation axis of the galvo scanner. Panel (b) is an example where the transmission grating is attached perpendicular to the axis of the galvo scanner. Panel (c) is an example where the reflection grating is attached parallel to the rotation axis of the galvo scanner. Panel (d) is an example where the reflection grating is attached perpendicular to the axis of the galvo scanner.

FIGS. 12A-12C show an example of spatial encoding according to arrangements of a diffraction grating and a galvo scanner. Panel (a) shows spatial encoding based on the galvo axis and diffraction grating attachment. Panel (b) shows the spatial encoding of the diffraction grating depending on the temporal scanning of the galvo scanner. Panel (c) shows a spatially encoded scanning pattern.

FIGS. 13A-13C show an example of a procedure for correcting RCM and SECM image distortion caused by the beam scanning mechanism. Panel (a) shows a simulated scanning pattern (shaded) and reference image (white grid). Panel (b) shows sample points on the scanning pattern and the target points after correction. Panel (c) shows the distortion corrected image.

FIGS. 14A-14B show an example of image distortion correction captured 1951 USAF target using SECM. Panel (a) shows a raw SECM image. Sample points and target points are indicated blue and red, respectively. Panel (b) shows the distortion corrected SEM image of 1951 USAF target.

### DETAILED DESCRIPTION

In accordance with some embodiments of the disclosed subject matter, mechanisms (which can include systems, methods, and apparatus) for signal correction for dynamic confocal microscopy are provided.

Dynamic image analysis is a process where pixelwise periodograms are typically generated by taking >500 subsequent images and analyzing the frequency of each pixel. These frequency components can then be related to subcellular metabolic activities. Previous attempts have been made at adopting dynamic image analysis to various optical coherence tomography (OCT) systems. However, due to its relatively low spatial resolution, it has been difficult to use dynamic OCT to visualize subcellular features.

Disclosed herein are embodiments of a new technology termed dynamic confocal microscopy including dynamic RCM/dynamic SECM, where SECM is a high-speed form of RCM which provides sub-cellular resolution. SECM uses a diffraction grating to spectrally encode a line-shaped field of view (FOW) with light of various wavelengths. Use of a spectrally encoded line in SECM enables line-based imaging of the biological sample without the need for the type of beam scanning mechanism that can significantly increase the imaging speed of RCM.

The procedures of dynamic image analysis can be combined with RCM and SECM imaging to obtain more pathological and morphological information from the biological sample. Accordingly, disclosed herein are embodiments of procedures for providing improved procedures for RCM and SECM and dynamic image analysis.

### Image Stabilization Methods for SECM/RCM Images

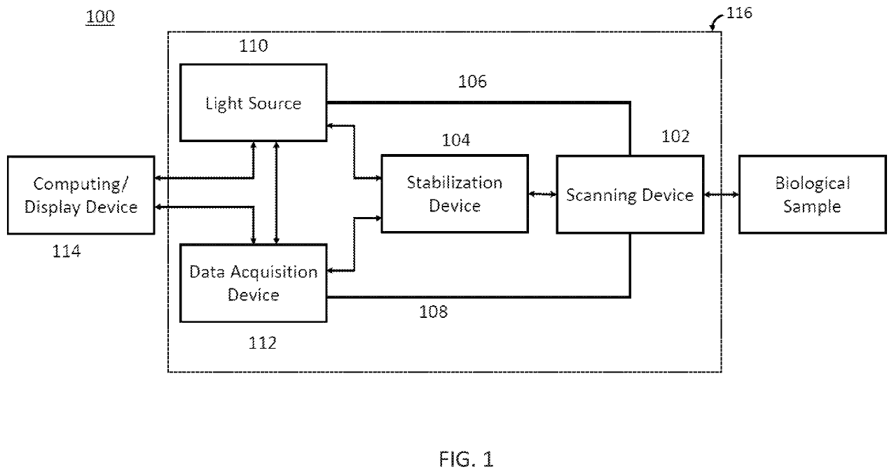

FIG. 1 shows an example 100 of an imaging system for performing dynamic RCM and dynamic SECM according to embodiments of the disclosed subject matter. As shown in FIG. 1, system 100 can include an imaging system 116 which can include one or more of scanning device 102, stabilization device 104, synchronized light source 110, and data acquisition device 112, which work together to facilitate stable beam scanning across the biological sample using scanning mechanisms such as galvo scanning, piezo scanning, Risley prism scanning, Nipkow spinning scanning, or other beam scanning mechanisms. Imaging system 116 may be in communication with one or more computing/display device 114.

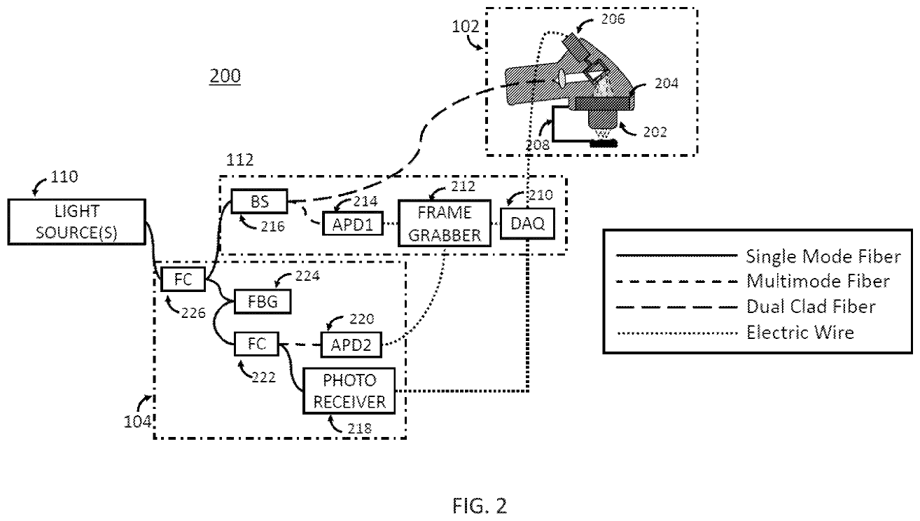

In some embodiments, stabilization device 104 can be mechanically coupled (e.g., using mechanisms including flexible joints, suction stabilizer, etc.) to scanning device 102 to ensure that any movement by the patient does not affect the imaging process. In some embodiments, stabilization device 104 can include mechanisms for stabilization of the focus. As described below in connection with FIG. 2, stabilization device 104 can include procedures for performing volumetric image grabbing over time and using image processing routines post-hoc to select the correct frames from the volumetric data. The volumetric image grabbing can be accomplished by moving the objective lens via mechanical devices (e.g., piezo scanner 204, focus tunable lens, etc.). In some embodiments, stabilization device 104 can be synchronized with light source 110 or data acquisition device 112. As described below with reference to FIG. 2, jitter-related artifacts can be corrected to generate high-quality dynamic RCM and dynamic SECM images.

In some embodiments, light source 110 can be optically coupled to scanning device 102 via optical waveguide 106 (e.g., optical fibers) such that the light is directed onto a biological sample. A portion of the light can be reflected by the biological sample on a focal plane back toward scanning device 102. And the reflected light can be delivered via optical waveguide 108 (e.g., optical fibers) to a data acquisition device 112.

In some embodiments, a computing/display device 114 can be coupled to light source 110 and data acquisition device 112. The computing/display device 114 can be configured to display, process, and/or save data, and in some embodiments the computing/display device 114 can control operation of light source 110 or data acquisition device 112.

FIG. 2 shows an example 200 arrangement of components that can be used to implement a system for dynamic RCM and dynamic SECM in accordance with some embodiments of the disclosed subject matter. As shown in FIG. 2, in some embodiments stabilization device 104 can be optically coupled to light source 110 via fiber coupler 226. The light from light source 110 may be directed to FBG 224, where the reflected light from the FBG 224 may be optically coupled to fiber coupler 222; in the case of a dynamic RCM system, stabilization device 104 may also include a scanning mirror to scan a line across the sample. Subsequently, the coupled reflected light can be delivered via fiber coupler 222 to a detector such as an avalanche photodiode (APD) 220 and/or to photoreceiver 218. In one particular example, a 90/10 fiber coupler can be used for fiber coupler 222, where 10% of the coupled light is delivered to APD 220 via a multimode fiber, where the information collected by APD 220 can be used for the time delay estimation between sweep of the light source 110. The remaining 90% of the coupled light from the 90/10 coupler can be delivered to data acquisition device 112, for example photoreceiver 218, to generate an electrical trigger to synchronize spectral acquisition with laser output on both the frame grabber 212 and the data acquisition device (DAQ) 210.

In some embodiments, data acquisition device 112 can include one or more of beam splitter (BS) 216, APD 214, Frame grabber 212, and/or DAQ 210. For example, light coupled from BS 216 via a dual clad fiber can be used to emit and detect a reflectance signal from the biological sample via scanning device 102. The reflectance signal can be optically coupled through a dual clad fiber and be conveyed to APD 214 to generate a standard RCM/SECM image or a dynamic RCM/SECM image.

In some embodiments, scanning device 102 can include synchronized beam scanning device 206, such as galvo, piezo, Risley and other beam scanning mechanisms. In one particular example of an SECM device, a diffraction grating can be attached to the galvo or other scanning device 206 to spread spectral light as the light is scanned so as to generate a two-dimensional (2D) scanning pattern. In one particular example of an RCM device, another scanning device such as a scanning mirror may be included and its movement may be coordinated with movement of scanning device 206 to generate a 2D scanning pattern. In a particular example, the galvo or other scanning device 206 may be stabilized using a feedback control loop. A position sensor associated with the galvo or other scanning device 206 can be used to continuously monitor the scanning angle. Data from the position sensor may then be fed back into the system, allowing for real-time correction of the scanning angle via control methods such as PID (Proportional-Integral-Derivative) control, fuzzy logic control, or other suitable control algorithms.

In some embodiments, a focus stabilization mechanism can be implemented. For example, objective lens 202 can be moved to vary focus length via a piezo stage 204.

In some embodiments, scanning device 102 can be coupled to the biological sample or patient to remove motion artifacts during data acquisition via coupling device 208. For example, coupling device 208 can include flexible joints or stabilizers which can be used to mechanically couple scanning device 102 to the biological sample.

To enable dynamic RCM/SECM imaging, we first disclose embodiments of procedures to reduce jitter-related artifacts in images. We then combine the jitter correction with line artifact removal procedures to generate high-quality dynamic SECM images.

Dynamic RCM/SECM is sensitive to instability and consequently to jitters derived from the unpredictable sweep rate variations of the laser, which create artifacts in RCM/SECM images and therefore need to be mitigated. Without being limited as to theory, the inherent instability of the swept-source laser is thought to be caused by both optical and electrical time delays in all the signal paths. One solution to this has been to introduce a fiber Bragg grating (FBG) for acquisition triggering of the sweeping laser pulse, where a Mach-Zehnder interferometer (MZI) has also used for lambda triggering to enable absolute timing of spectral events. Thus, while the combined configuration of an FBG plus an MZI has been used for jitter correction in phase-sensitive optical coherence tomography, further improvements are needed.

Accordingly, various embodiments disclosed herein facilitate improved procedures for collection of dynamic RCM/SECM images. As part of these improved procedures, we first developed a novel method to stabilize RCM/SECM images by (1) visualizing the actual time delay between swept spectrums using “only the FBG-based signal,” then (2) estimating the shift using cross-correlation, and (3) correcting the shift using circular shifting methods to measure and compensate for spectral jitters.

The following provides descriptions of various embodiments of dynamic RCM and SECM. In various embodiments, the post-processing routine includes one or more of: (1) use of the procedure described above for image stabilization, (2) stripe artifact removal in the Fourier domain, (3) dynamic image analysis to calculate pixel wise periodograms, and (4) dynamic SECM reconstruction using mean frequencies in predetermined frequency ranges and average pixel intensities in false color red-green-blue (RGB) color space. In examples provided below, embodiments of the disclosed procedures are validated using ex-vivo swine colon tissue.

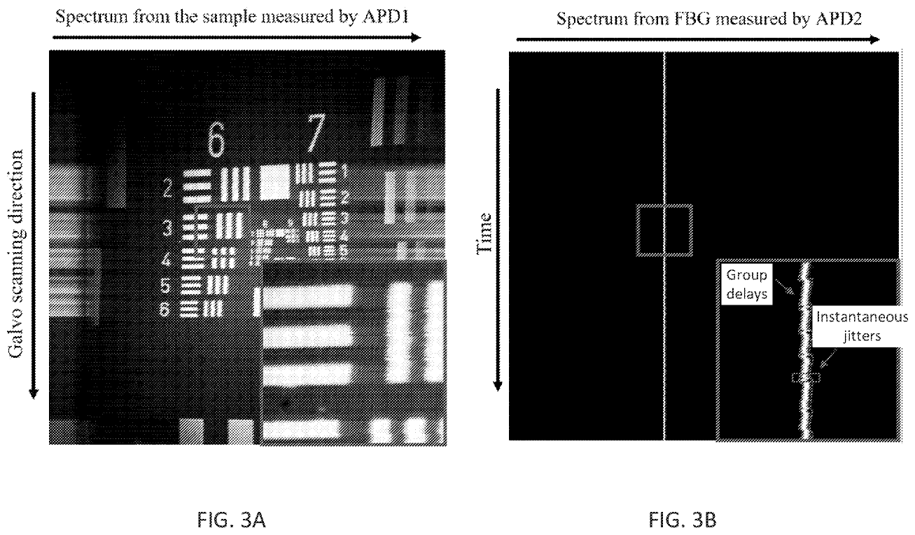

The effect of the spectral fluctuations approach can be seen in FIG. 3(a), which is an image of a United State Air Force (USAF) 1951 resolution chart with a magnified inset (lower right; acquired using APD1). The image shows that there are two types of artifacts in the horizontal direction: group delays and instantaneous jitters (see FIG. 3(a) inset). Both artifacts have different patterns in each acquired image and thus each image needs to be corrected for these artifacts individually. The same profile of horizontal artifacts is observed in the time-stacked FBG image (acquired using APD2) as shown in FIG. 3(b). Because the signals detected by APD1 and APD2 are simultaneously measured on the same frame grabber, they have the same time delays for each swept spectrum. Since the FBG signal of FIG. 3(b) is detected only within a narrow bandwidth, the acquired APD2 image shows a thin vertical line, where the horizontal artifacts can be clearly seen. Hence, the FBG image could be used to compensate for the horizontal artifacts in the sample image.

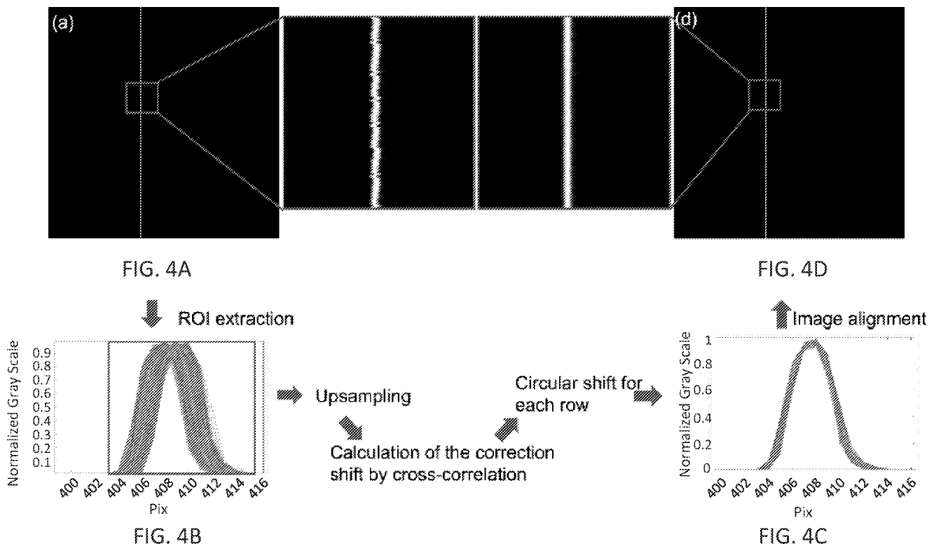

FIG. 4(a) and 4(b) show the FBG-based image and vertically stacked gray scale profiles of the FBG signals, respectively. Only a few pixels (e.g., between 5-20 pixels) in the image row contain the FBG signal, so we can adjust a region of interest (ROI) in accordance with the FBG signal width so that subsequent analyses are limited to these signal-containing pixels. A number of deviations in the stacked FBG signals can be observed, which indicates that there are high variations in acquisition time delays. To estimate the time delay differences with high precision mesh, we apply a 10× linear interpolation to the FBG signal for each row. We can then arbitrarily assign one row of the FBG signal as the reference that the remaining rows will be adjusted against. We then calculate a correction shift as being the pixel number offset at which the cross-correlation between each row and the reference row is maximized. Then, the FBG image can be aligned by using a circular shift as shown in FIG. 4(c). The row-wise compensation values are then applied to the image. As shown in FIG. 4(d) (particularly in the inset), the corrected FBG image shows the vertically aligned FBG signals without horizontal artifacts.

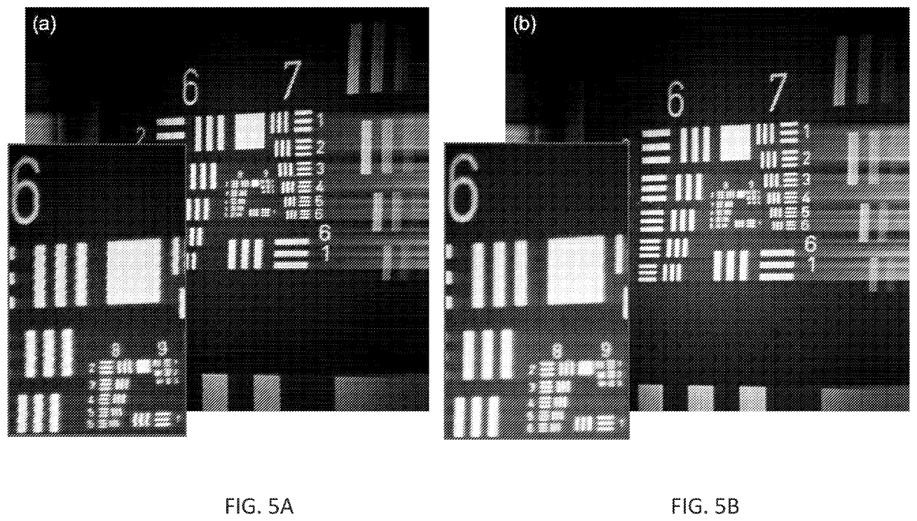

FIG. 5(a) and 5(b) show the raw SECM image of the USAF 1951 resolution chart and the SECM image after correcting using row wise correction shifts of the FBG image, respectively. As seen in FIG. 5(b), the horizontal image artifacts in FIG. 5(a) can be completely resolved by the disclosed procedures. Among the advantages of these procedures is the fact that the FBG is optically separated from the scanning part, so the image jitter correction can be performed agnostic of the sample structure. In addition, as indicated above the cross-correlation procedure can be carried out based on an analysis of a relatively small number of pixels, making the disclosed approach applicable to a real-time procedure. In various embodiments, the accuracy of the jitter correction may be enhanced by using a narrower FBG.

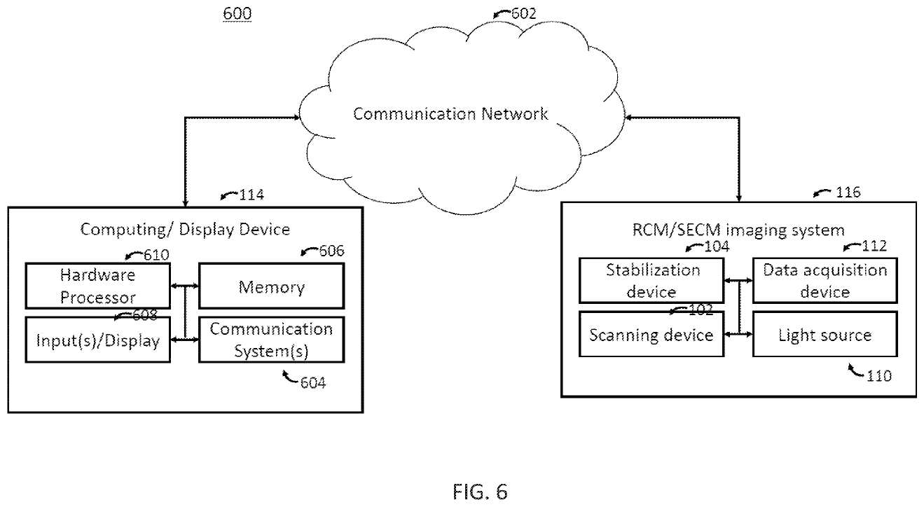

FIG. 6 shows an example 600 of hardware that can be used to implement a computing device and server in accordance with some embodiments of the disclosed subject matter. As shown in FIG. 6, in some embodiments computing and display device 114 can include a hardware processor 610, one or more input and display 608 device, one or more communication systems 604, and/or memory 606. In some embodiments, hardware processor 610 can be any suitable processor or combination or processors, such as a CPU, a GPU, an MPU, a FPGA, a dedicated image processor, etc.

In some embodiments, memory 606 can include any suitable storage device or device that can be used to store instructions, values, etc., that can be used, for example, by hardware processor 610 to present content using display 608, to communicate with RCM/SECM imaging system 116 via communication system 604. Memory 606 can include any suitable volatile memory, non-volatile memory, storage, or any suitable combination thereof.

In some embodiments communication system 604 can include any suitable hardware, firmware, and/or software or communicating information over communication network 602 and/or any other suitable communication network. For example, communication systems 604 can include one or more transceivers, one or more communication chips and/or chip sets, etc. In a more particular example, communication system 604 can include hardware, firmware and/or software that can be used to establish a Wi-Fi connection, a Bluetooth connection, a cellular connection, an Ethernet connection, etc.

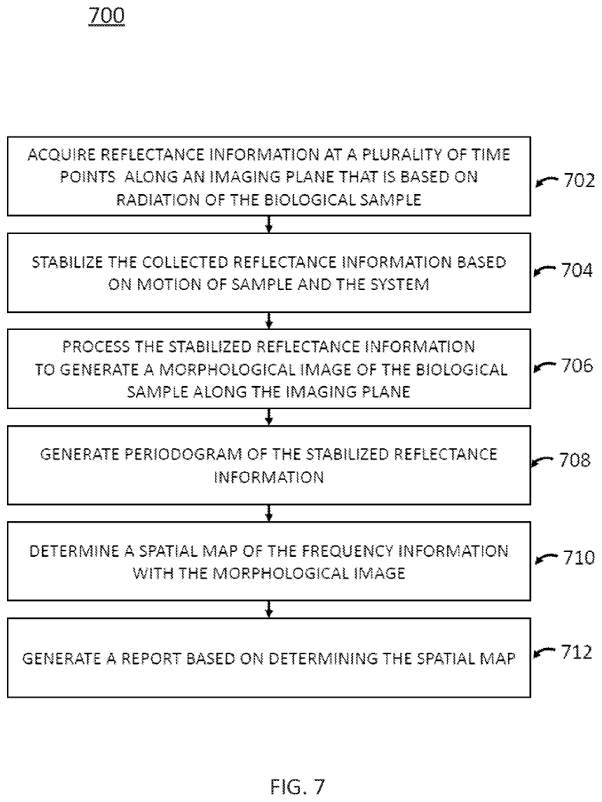

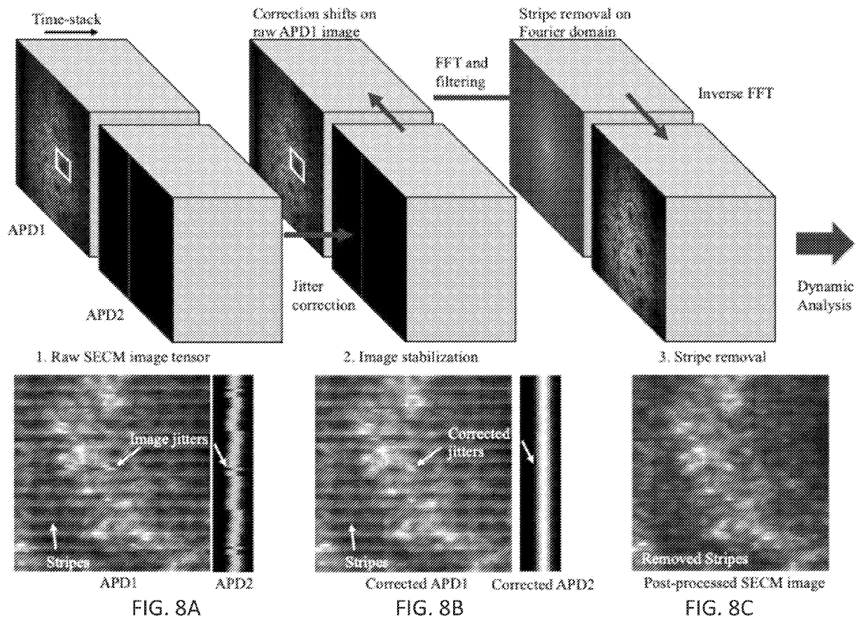

FIG. 7 shows an example 700 of a process for capturing and creating image data and functional dynamic data from biological sample in accordance with some embodiments of the disclosed subject matter. As shown in FIG. 7, at 702, process 700 can acquire reflectance information at a plurality of time points along an imaging plane that is based on radiation of the biological sample. The reflectance information can be acquired via any suitable technique or combination of technique to generate reflectance confocal data using the returning light from the sample. For example, as described above in the connection with FIG. 2, light from a scanned SECM device (e.g., using a galvo or other scanning device) can be detected; in the case of an RCM device, a scanning mirror may be used to scan lines on the sample and may be coordinated with a galvo or other scanning device to scan the surface of the sample (e.g., to obtain 2D images). At 704, process 700 can stabilize the collected reflectance information to reduce, prevent, and/or correct for motion of the sample and/or the data collection system, where the stabilization can be achieved via various methods including those disclosed herein. In some embodiments, and as described below in connection with FIG. 8, at 704 process 700 can use FBG image-based stabilization.

In some embodiments, post-hoc routines-based focus stabilization methods can be used which include 3D image (i.e., volume) grabbing via a variable focal length objective lens or a moving objective lens. In a particular example of collecting 3D/volume data from a sample in which the sample and/or data collection system is moving, the correct frames among the 3D/volume image data can be selected and can be subsequently used and processed to generate the dynamic RCM/SECM images.

In some embodiments, motion unwarping stabilization can be used at 704. For example, blood flow or any other internal motion (e.g., due to movement of an organ such as the heart or lung) can warp the tissue. This can generate artifacts that may appear when performing processing to obtain the dynamic image data. Therefore, various unwarping stabilization procedures may be employed, such as feature extraction, normalization, regularization, and/or machine learning techniques. For example, features on the reflectance information that is acquired at a plurality of time points as in 702 can be used for pixel or subpixel registration. In addition, one or more features in the Fourier domain of reflectance data acquired at a plurality of time points as in 702 can be utilized to remove periodic movement noise or bulk movement noise.

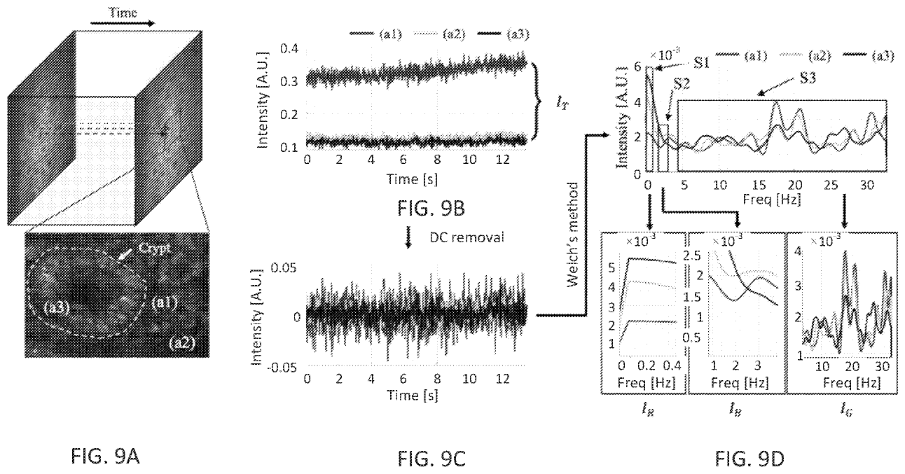

At 706, process 700 can process the stabilized reflectance information to generate a morphological image of the biological sample along the image plane. In various embodiments, the processing may be performed using a processor configured to receive the stabilized reflectance information. At 708, process 700 can generate a periodogram based on the stabilized reflectance information. For example, as describe below with connection with FIG. 9, time stacked RCM/SECM images can be used to generate a pixelwise periodogram by utilizing signal processing methods such as Welch's method, Bartlett's method, etc., where the periodogram generation may be performed using the processor. The frequency information in the periodograms may reflect temporal modulation induced by dynamic functions of the biological tissue. At 710, process 700 can determine a spatial map of the frequency information with the morphological image, where the determination may be performed using the processor. The spatial map of the frequency information may represent the dynamic function of the biological sample. Finally, at 712, process 700 can generate a report based on determining the spatial map, which report may be generated using the processor.

### Dynamic Analysis on SECM Image

FIG. 8 shows an example of post-processing routines, prior to dynamic SECM analysis, which involve two channel (e.g., APD1, APD2 in FIG. 1) acquisition, jitter correction, and line artifact removal. In the example, a 454 μm×454 μm section of swine colon was used to generate an SECM image. The time-stacked raw image stacks (FIG. 8(a)) including the raw SECM sample image (APD1) and FBG image (APD2) were processed with the previously described jitter correction routine (FIG. 8(b)). After jitter correction, line artifacts remain in the image, where these artifacts are known to be derived from a high-scattering structure in the light path. Accordingly, several Fourier domain-based stripe removals have been implemented to selectively suppress only the stripe artifacts without diminishing the sample signal (FIG. 8(c)).

The stripe artifacts have uniform spacing with each other and are amenable to spatial-frequency domain filtering methods. Other methods also can be added in post-processing, such as elastic image unwarping transformation, which conceivably could compensate for the motion artifact of the sample itself.

FIG. 9 shows an example in which the algorithm for dynamic RCM/SECM involves extracting intensity values over time for all pixels, subtracting out the very low frequency components, applying Welch decomposition methods, and then manually setting frequency bands and generating reconstructions. As shown in FIG. 9(a), the post-processed SECM image stack is used as an input for dynamic SECM. The SECM images are acquired from swine colon and, as shown in the inset in FIG. 9(a), there are three distinctive parts on the image: (a1) an epithelial cell on the crypt, (a2) stroma between crypts, and (a3) crypt lumen. FIG. 9(b) shows the pixelwise intensity graphs of each part, where (a1) has the highest intensity profiles, (a2) has medium intensity levels, and (a3) is the lowest intensity level, as the crypt lumen is basically empty space. The mean intensity of each pixel is saved in the temporal averaged image, IT. To analyze dynamic properties, we removed DC components by applying a low-pass filter as shown in FIG. 9(c). SECM image stacks from which the DC components have been removed are then processed by Welch's method to get a pixelwise periodogram as shown in FIG. 9(d). Here, we used 1/16 of the data length and 50% as a window and overlap for the Welch's method, respectively. We divided the entire frequency region into three bands: S1, S2, and S3, although in various embodiments the frequency region can be divided into fewer or more bands as needed. In some embodiments, the selection of frequency region is tuned manually to maximize contrast. In this instance, we determined each frequency region as follows: 0.0-0.3 Hz, 0.7-3.3 Hz, and 4.4-32.5 Hz, respectively. The mean frequency is then calculated and saved in each channel of an RGB image, I_{R}, I_{B}, and I_{G}, respectively. The final RGB image is generated by multiplying (I_{R}, I_{G}, I_{B}) by I_{T} at each pixel (FIG. 9(d)).

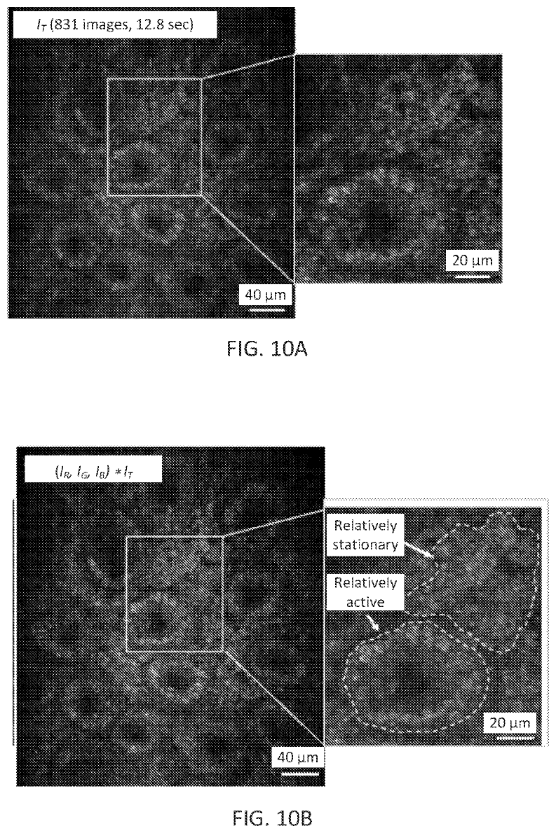

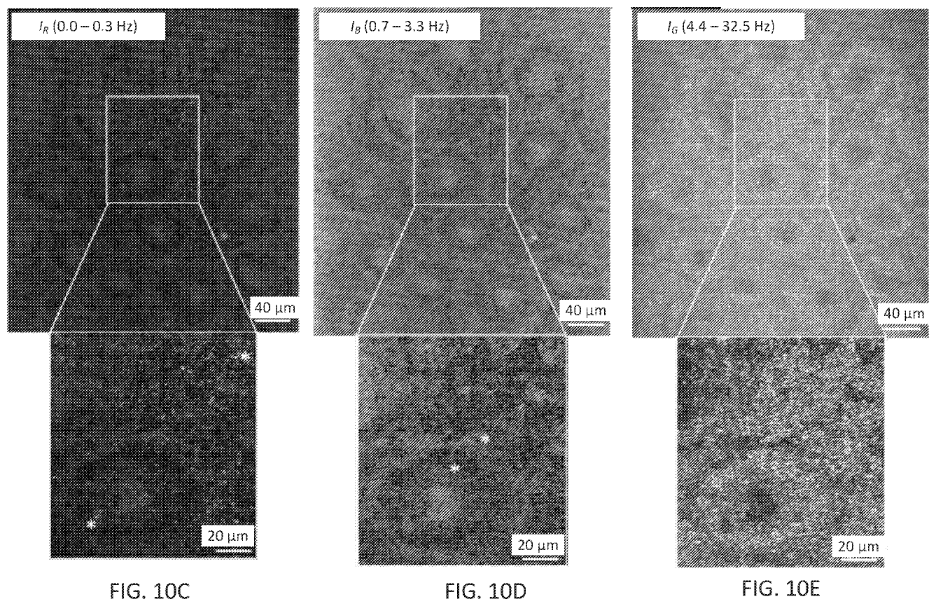

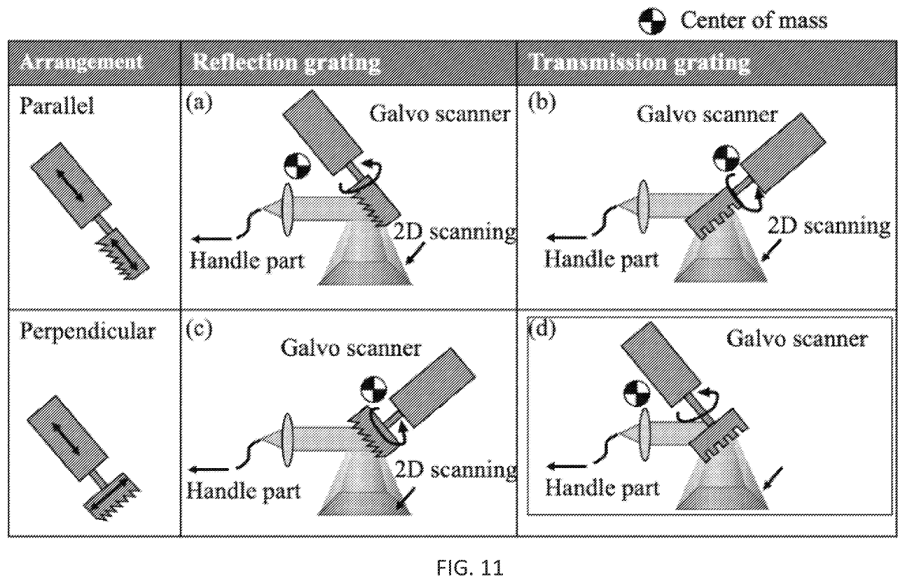

The dynamic SECM reconstructions can be seen in FIG. 10. FIG. 10(a) shows a temporal averaged image, and FIG. 10(b) is the dynamic SECM result. Here, we used 831 SECM images which cover a period of 12.8 seconds. As shown in FIG. 10(c) and its inset, the stationary parts are emphasized, which are denoted by yellow asterisks. The stationary parts may be cell nuclei or other relatively motionless subcellular structures. At the intermediate frequency region, the stromal structure is highlighted as a bright color, as shown in FIG. 10(d) and its zoomed image. The several dark dots indicated by the yellow asterisks would likely be the active cells such as epithelial and stromal cells, which have higher frequency components. FIG. 10(e) shows the higher frequency component image, and subcellular motions are emphasized in this image. Hence, the RGB dynamic SECM image can show the different imaging results at the static cellular components with red, stromal background with blue, and subcellular motions with green colors, respectively. Furthermore, it is possible to show which part of the sample has more metabolic activities as shown in the zoomed image of FIG. 10(b). We can clearly see that the epithelial cells on the crypt have higher frequencies than that of the stroma, as indicated by the dotted white area. Without being limited as to theory, these differences may be due to the fact that digestive activity occurs more frequently in the crypt than the stroma.

### Grating-Attached Galvo Scanning

The noninvasive, rapid imaging ability and high spatial resolution of SECM can reduce false negative diagnostic errors and provide an exact excision margin, resulting in a low recurrence rate. The use of fiber optics to deliver/collect light make the technique suitable for in vivo applications. To achieve in vivo/handheld SECM imaging, there exists a variety of scanning methods. A spatially-encoded scanning method (slit-type SECM) has been implemented. Since a slit aperture can convert an incident beam into a line beam, two-dimensional scanning can be realized by illuminating the line beam to a diffraction grating with a low-cost setup. However, slit aperture-based confocal microscopy suffers from a degraded axial resolution compared to use of a circular pinhole aperture. As an alternative 2D scanning method, a mechanical scanner can be used to temporally scan the line beam generated by the diffraction grating. For example, a brushless DC motor or servo motor has been used to rotate a patterned diffraction disk. The patterned disk is designed to spatially encode the incident light, and rotating motors are capable of high loads and speeds. Thus, this method can provide both fast imaging and design versatility; however, complicated manufacturing procedures are required to fabricate the patterned disk, and it is hard to integrate all moving components into a handheld probe. One SECM configuration uses a galvanometric (galvo) scanner and the diffraction grating. To improve upon these technologies for hand-held scanning, we now report a new configuration which incorporates a galvanometer scanner and gratings for manipulation of a scanning pattern and synchronization for additional 3D volumetric imaging. As a particular example of this more general innovation, a diffraction grating can be attached to the spindle of the galvo scanner, which can further reduce the imaging probe dimension.

In various embodiments, a grating-attached galvo arrangement may have various forms, some of which are shown in FIG. 11. The grating can be attached in parallel (FIG. 11(a) and 11(b)) or perpendicular (FIG. 11(c) and 11(d)) to the galvo scanner. In addition, either reflective (FIG. 11(a) and 11(c)) or transmissive gratings (FIG. 11(b) and 11(d)) can be used. The center of masses of each arrangement is expressed. To easily maneuver the handheld SECM imaging, the center of mass needs to be adjacent to the handle part where the illumination fiber coming from. Both the cases in FIG. 11(a) and 11(d) have a balanced center of mass.

### Grating-Attached Galvo Scanning Distortion Compensation

One issue that needs to be resolved related to hand-held scanners is to correct for distortions such as fan-shaped image distortions that may arise from the scanner not being held perfectly aligned with the surface of the sample and/or from a sample that is not completely flat. Thus, some embodiments provide for a galvo scanning distortion compensation procedure, as disclosed below.

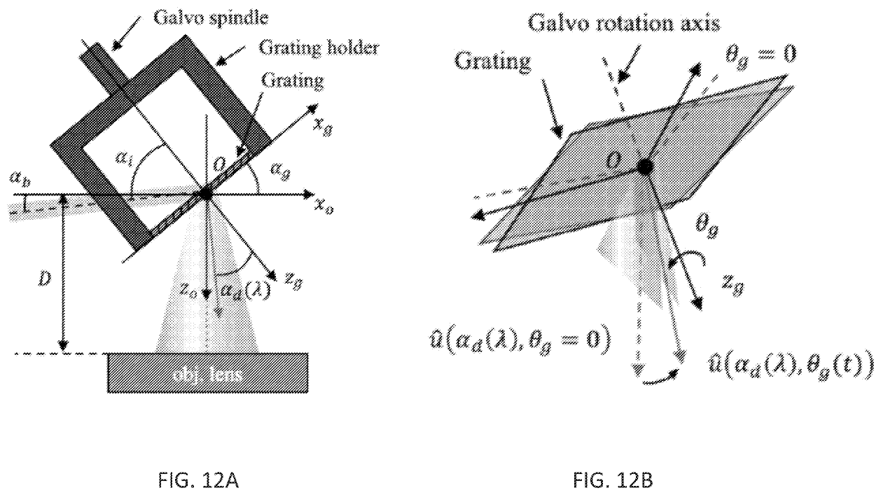

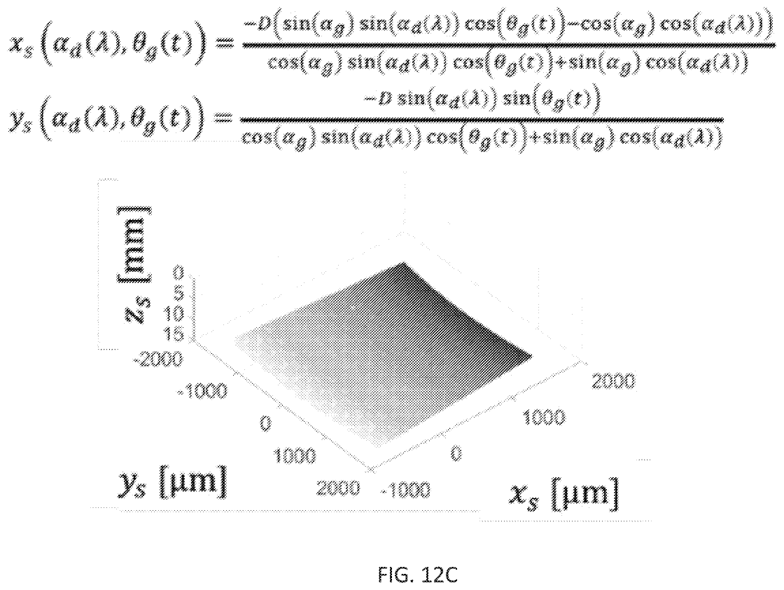

The parameters of the diffracted beam by the grating are shown in FIG. 12(a). In various embodiments, all of the coordinates discussed below can be continuously monitored and can be accurately recorded or adjusted through the feedback control loop of the galvo or other scanning device, which maintains the actual position of the scanner. “O” indicates the origin of the reference coordinate, which is affixed to the center of the diffracted beam on the grating. “zₒ” is a reference z-axis which is perpendicular to the objective lens, and “xₒ” extends in the direction the light enters. “z_{g}” is the normal axis of the grating which is connected to the galvo spindle by grating holder. “α_{b}” is the angle between the incident beam and “xₒ.” “αᵢ” is the incident angle of the beam into the grating. “α_{d}(λ)” is the diffraction angle which can be expressed as follows: α_{d}(λ)=a sin (λf_{g}−sin αᵢ) where f_{g} is the spatial frequency of the grating. Thus, the length of the one spectrum line (A-line) is determined by the wavelength bandwidth and f_{g}. D is the offset between the origin and the first surface of the objective lens. As shown in FIG. 12(b), the A-line is moved as the galvo rotates with an angle of θ_{g}. The unit vector of a diffracted beam is û (α_{d}(λ), θ_{g}(t)) and depends on both wavelength and θ_{g}. The derived mathematical equation of scanning pattern is expressed on FIG. 12(c). This shape is called “fan-shaped pattern”, it inherently provides an image distortion which can be fixed by the mathematical formula of the scanning pattern we derived.

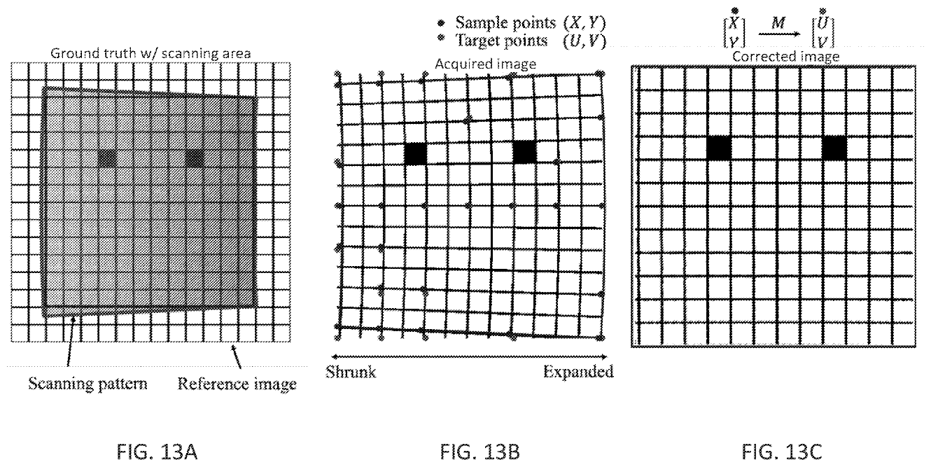

A diagram of the steps of a procedure for image distortion correction of a fan-shaped scanning pattern is shown in FIG. 13. As shown in FIG. 13(a), the simulated scanning pattern (red shaded area) is generated on the reference image with a grid pattern. The blue area is a ground truth image after the distortion correction. The acquired image within the red area will be shown as FIG. 13(b), and we can clearly see the left part of the image is shrunk due to the larger scanning area. To recover the image, several reference points (X, Y) are extracted from the equation in FIG. 12(c). Then, (X, Y) needs to be stretched to the target points (U, V) on the ground truth. Here, we selected 26 points and adopted a polynomial fitting to find a transformation matrix between (X, Y) and (U, V). FIG. 13(c) is the corrected image result, and it can be added to the SECM image for more reliable imaging results.

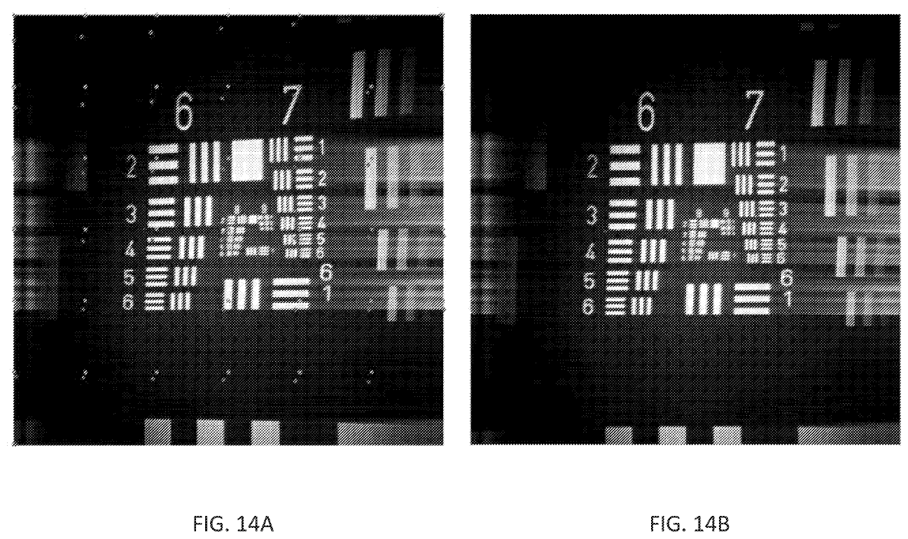

FIG. 14 shows an example of image distortion correction applied to an image of the 1951 USAF target captured using SECM. In FIG. 14(a), the raw SECM image of the USAF 1951 resolution target has a fan-shaped image distortion, where the numberings of group six and seven are not in the same image row. We can select a few sample and target points on the acquired SECM image as indicated by the blue and red points, respectively. Then, the transformation matrix is derived to correct the image distortion. The scanning parameters such as the wavelength range of the swept source and the galvo angle can be also estimated while correcting the image distortion. The corrected SECM image is shown in FIG. 14(b), and we can clearly see that the distortion is substantially fixed.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

1-25. (canceled)

26. An apparatus for signal correction for dynamic confocal microscopy, comprising:
a light source configured to be optically coupled to a sample;
a fiber Bragg grating optically coupled to the light source;
a first detector and a second detector; and
a controller in communication with the light source and the first detector and the second detector, the controller being configured to:
direct a first portion of an output of the light source to the sample,
collect, using the first detector, first light returned from the sample to generate a sample image,
direct a second portion of the output of the light source to the fiber Bragg grating,
collect, using the second detector, second light returned from the fiber Bragg grating to generate a reference image,
the reference image comprising a plurality of rows,
analyze the reference image to identify an amount of delay in each row of the plurality of rows of the reference image, and
produce a corrected sample image by adjusting each row of the plurality of rows of the sample image based on identifying the amount of delay in each row of the plurality of rows of the reference image.

27. The apparatus of claim 26, wherein the light source comprises a swept-source laser, and
wherein the controller, when directing the first portion of the output of the light source to the sample, is further configured to:
direct the first portion of the output of the swept-source laser to the sample, and
wherein the controller, when directing the second portion of the output of the light source to the fiber Bragg grating, is further configured to:
direct the second portion of the output of the swept-source laser to the fiber Bragg grating.

28. The apparatus of claim 26, wherein the controller, when analyzing the reference image to identify an amount of delay in each row of the plurality of rows of the reference image, is further configured to:
perform a cross-correlation between a reference row and each of a plurality of rows of the reference image,
identify an amount of shift between the reference row and each of the plurality of rows of the reference image, and
identify the amount of delay in each row of the reference image based on identifying the amount of shift.

29. The apparatus of claim 26, wherein the controller is further configured to:
obtain a plurality of sample images each of which corresponds to a different time point,
wherein each sample image of the plurality of sample images comprises a plurality of pixels each representing an intensity value, and
wherein the controller is further configured to:
produce a plurality of time courses of intensity values for each of the plurality of pixels of the plurality of sample images, and
wherein the controller, when producing the corrected sample image, is further configured to:
produce the corrected sample image by reducing a stripe artifact in each of the plurality of time courses of intensity values using frequency domain processing.

30. (canceled)

31. The apparatus of claim 29, wherein the controller is further configured to:
generate a plurality of periodograms corresponding to each of the plurality of time courses of intensity values, and
divide each of the plurality of periodograms into a plurality of frequency bands.

32. The apparatus of claim 31, wherein the controller, when generating a plurality of periodograms corresponding to each of the plurality of time courses of intensity values, is further configured to:
generate the plurality of periodograms using Welch's method.

33. The apparatus of claim 31, wherein the controller, when dividing each of the plurality of periodograms into a plurality of frequency bands, is further configured to:
adjust an appearance of the corrected sample image based on dividing each of the plurality of periodograms into the plurality of frequency bands,
wherein at least one of a color or a brightness of each of the plurality of pixels is adjusted based on the periodogram of the respective pixel.

34. The apparatus of claim 33, wherein at least one of the color or brightness of each of the plurality of pixels of the corrected sample image represents an activity level of the sample in a region corresponding to the pixel.

35. The apparatus of claim 26, further comprising a galvanometer scanner in communication with the controller,
wherein the galvanometer scanner is coupled to a diffraction grating, and
wherein the controller, when directing a first portion of an output of a swept-source laser to a sample, is further configured to:
direct the first portion of the output of the swept-source laser to the sample using the diffraction grating coupled to the galvanometer scanner.

36. The apparatus of claim 35, wherein the diffraction grating comprises a reflection grating or a transmission grating.

37. (canceled)

38. The apparatus of claim 35, wherein the diffraction grating is coupled to the galvanometer scanner in a parallel configuration or a perpendicular configuration.

39. The apparatus of claim 35, wherein the controller is further configured to:
correct the sample image for a fan-shaped distortion pattern caused by scanning the sample with the diffraction grating coupled to the galvanometer scanner.

40. The apparatus of claim 39, wherein the controller, when correcting the sample image for a fan-shaped distortion pattern, is further configured to:
extract a plurality of reference coordinates from the sample image,
determine a plurality of target coordinates in a corrected sample image corresponding to the respective plurality of reference coordinates,
generate a transformation matrix to transform the plurality of reference coordinates to the plurality of target coordinates, and
generate the corrected sample image based on applying the transformation matrix to the sample image.

41. The apparatus of claim 39, wherein the controller is further configured to identify at least one of a wavelength range of the swept-source laser or an angle of the galvanometer scanner based on correcting the sample image for the fan-shaped distortion pattern.

42. The apparatus of claim 26, wherein the dynamic confocal microscopy comprises at least one of spectrally-encoded confocal microscopy (SECM) or reflectance confocal microscopy (RCM).

43. The apparatus of claim 26, further comprising a scanning mechanism comprising at least one of galvo scanning, piezo scanning, Risley prism scanning, or Nipkow spinning scanning, and
wherein the controller, when directing the first portion of the output of the light source to a sample, is further configured to:
scan the light source across the sample using scanning mechanism.

44. The apparatus of claim 26, further comprising a data collection system comprising at least one of the first detector or the second detector,
wherein the controller, when collecting the first light returned from the sample and collecting the second light returned from the fiber Bragg grating, is further configured to:
stabilize the collected first light and second light to at least one of reduce, prevent, or correct for motion of at least one of the sample or the data collection system.

45. The apparatus of claim 44, wherein the controller, when stabilizing the collected first light and second light, is further configured to:
apply unwarping stabilization processing to the collected first light and second light.

46. The apparatus of claim 35 further comprising a scanning device comprising the light source to the sample,
wherein the controller, when directing the first portion of the output of the light source to the sample and directing the second portion of the output of the light source to the fiber Bragg grating, is further configured to:
couple the scanning device to the sample.

47. (canceled)

48. The apparatus of claim 46, wherein the scanning device further comprises a position sensor, and
wherein the controller, when directing the first portion of the output of the light source to the sample and directing the second portion of the output of the light source to the fiber Bragg grating, is further configured to:
obtain position information for the scanning device using the position sensor, and
correct a position of the scanning device based on the position information.

49. The apparatus of claim 46, wherein the galvanometer scanner and the diffraction grating are disposed within the scanning device, and
wherein the scanning device comprises a hand-held housing.

50. The apparatus of claim 26, wherein the controller, when collecting the first light returned from the sample and collecting the second light returned from the fiber Bragg grating, is further configured to:
stabilize a focus along a depth axis of the sample.

51. The apparatus of claim 50, further comprising at least one of an objective lens or a variable focal length objective lens,
wherein the controller, when stabilizing the focus along the depth axis of the sample, is further configured to at least one of:
move an objective lens coupled to the light source and the first detector,
provide a variable focal length objective lens coupled to the light source and the first detector, or
obtain volumetric data from the sample and subsampling the volumetric data to obtain the sample image.
